(19) United States
(12) Patent Application Publication
(10) Pub. No.: US 2025/0336117 A1
(43) Pub. Date: Oct. 30, 2025

(54) INTERACTIVE SYSTEM FOR VISUALIZING AND MANAGING A DAILY SCHEDULE OF EVENTS AND ACTIVITIES

(71) Applicant: TIMEUNDERSTOOD LLC, Hilton Head Island, SC (US)

(72) Inventor: David Edward ELLIOTT, Hilton Head Island, SC (US)

(21) Appl. No.: 19/183,027

(22) Filed: Apr. 18, 2025

Related U.S. Application Data
(60) Provisional application No. 63/640,527, filed on Apr. 30, 2024.

(51) Int. Cl. G06T 11/20; G06Q 10/1093

(52) U.S. Cl. CPC G06T 11/206; G06Q 10/1093; G06T 2200/24

(57) ABSTRACT

In various embodiments, a computer implemented method comprises determining a plurality of increments associated with a day, determining a plurality of bars associated with the plurality of increments, wherein each of the plurality of bars is associated with a respective increment of the day, determining a respective height and a respective shading for each of the plurality of bars based on which increment of the day to which a respective bar corresponds, and generating the user interface, wherein the user interface comprises the plurality of bars.

### CROSS-REFERENCE TO RELATED APPLICATIONS

This application claims priority benefit to U.S. Provisional Application entitled “AN INTERACTIVE SYSTEM FOR VISUALIZING AND MANAGING A DAILY SCHEDULE OF EVENTS AND ACTIVITIES,” filed Apr. 30, 2024, and having Ser. No. 63/640,527. The subject matter of this related application is hereby incorporated by reference in its entirety.

### BACKGROUND

For patients and users with cognitive deficits, adhering to a daily schedule of activities and tasks can be important. For example, users might have a medication schedule, a daily physical activity schedule, a meal schedule, and periodic appointments, such as appointments with medical providers. However, adhering to such a daily schedule can also prove to be difficult for certain users. These users may not possess the ability to gauge how much time has passed during the day or estimating what time of day it is at any given moment.

Failing to adhere to a daily and regular schedule can cause mental and physical ailments or exacerbate existing ailments. Simply providing some users with a clock or a daily schedule is insufficient to help the user adhere to a daily schedule. Some users may have cognitive impairments that render the use of a traditional clock or calendar to be difficult for adherence to a daily schedule. Therefore, what is needed in the art are more effective techniques for presenting information about a daily schedule to improve adherence to the daily schedule for certain users with cognitive deficits.

### SUMMARY

In various embodiments, a computer-implemented method comprises determining a plurality of increments associated with a day, determining a plurality of bars associated with a plurality of bars, wherein each of the plurality of bars is associated with a increment of the day, determining a respective height and a respective shading for each of the plurality of bars based on which increment of the day to which a respective bar corresponds, and generating the user interface, wherein the user interface comprises the plurality of bars.

At least one technical advantage of the disclosed techniques herein relative to the prior art is that, with the disclosed techniques, a user interface is presented to the user the conveys important information about the user's daily schedule, such as appointments, mealtimes, activities, and other information that can be important to convey to a user that may have cognitive deficits. Another advantage is that the user interface conveys time of day relative to events in a user's schedule to users with cognitive deficits. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, can be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

The patent or application file contains at least one drawing executed in color. Copies of this patent or patent application publication with color drawing(s) will be provided by the Office upon request and payment of the necessary fee.

FIG. 1 illustrates a schematic diagram of a system according to various embodiments.

FIG. 2 illustrates an example user interface according to various embodiments.

FIG. 3 illustrates an example user interface according to various embodiments.

FIG. 4 illustrates an example user interface according to various embodiments.

FIG. 5 illustrates an example user interface according to various embodiments.

FIG. 6 illustrates an example user interface according to various embodiments.

FIG. 7 illustrates an example user interface according to various embodiments.

FIG. 8 illustrates an example user interface according to various embodiments.

FIG. 9 illustrates an example user interface according to various embodiments.

FIG. 10 illustrates an example user interface according to various embodiments.

FIG. 11 illustrates an example user interface according to various embodiments.

FIG. 12 illustrates an example user interface according to various embodiments.

FIG. 13 illustrates an example user interface according to various embodiments.

FIG. 14 illustrates an example user interface according to various embodiments.

FIG. 15 illustrates a flowchart of a method according to various embodiments.

### DETAILED DESCRIPTION

In the following description, numerous specific details are set forth to provide a more thorough understanding of the various embodiments. However, it will be apparent to one skilled in the art that the inventive concepts can be practiced without one or more of these specific details. For explanatory purposes, multiple instances of like objects are symbolized with reference numbers identifying the object and parenthetical numbers identifying the instance where needed.

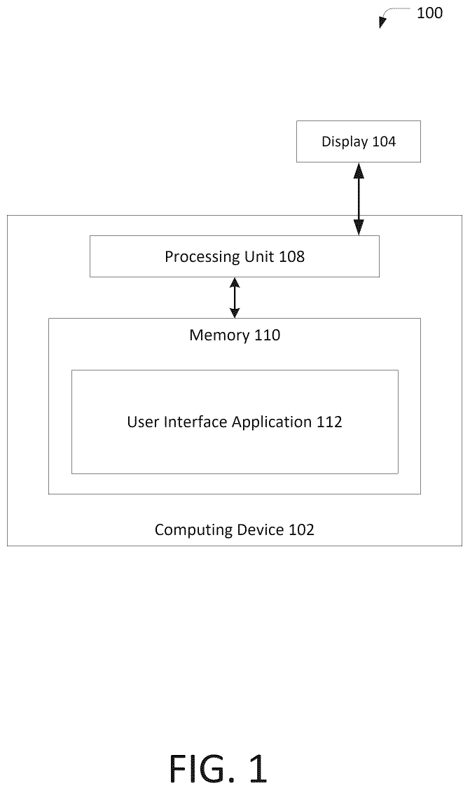

FIG. 1 illustrates a block diagram of an example system 100 configured to implement one or more aspects of the present disclosure. As shown, the system 100 includes, without limitation, a computing device 102 and a display 104. Computing device 102 includes, without limitation, one or more processors such as processing unit 108 and further includes one or more memories such as a memory 110. The memory 110 includes, without limitation, a user interface application 112. In some implementations of the disclosure, computing device 102 executing user interface application 112 generates and transmits a user interface according to various embodiments to another computing device that is remotely located from computing device 102. The remotely located computing device renders a user interface that is generated by user interface application 112, according to various embodiments.

Computing device 102 is a device such as a computer, virtual machine, or other device having one or more processing unit 108. In some embodiments, computing device 102 is included in one or more devices, such as consumer products (e.g., portable speakers, gaming consoles, entertainment systems, etc.), vehicles (e.g., the head unit of a car, truck, van, bus, train, airplane, or other vehicle), smart home devices (e.g., smart lighting systems, security systems, digital assistants, etc.), communications systems (e.g., conference call systems, video conferencing systems, etc.), mobile devices (e.g., smart phones, tablets, etc.), computers, and so forth. Computing device 102 is configured to generate a user interface according to various examples and cause a display 104 to render the user interface.

The display 104 represents any technically feasible display that can render a user interface generated by user interface application 112. The display 104 can be connected to computing device 102 via a wired or wireless interface. In some embodiments, the display 104 executes a browser application that renders a user interface comprising markup language and/or client-side executable code that is generated by user interface application 112.

Processing unit 108 controls the overall operation of computing device 102. Processing unit 108 is configured to read and write data from memory 110. Processing unit 108 can include any suitable hardware processor or combination of hardware processors, including one or more central processing units (CPUs), graphics processing units (GPUs), digital signal processors (DSPs), field-programmable gate arrays (FPGAs), or application-specific integrated circuits (ASICs), and/or any other type of processing unit, or a combination of processing units, such as a CPU configured to operate in conjunction with a GPU. In general, processing unit 108 can be any technically feasible hardware unit capable of processing data, executing instructions, and/or performing computing tasks.

Memory 110 can include a random-access memory (RAM) module, a flash memory unit, or any other type of memory unit or combination thereof. The processing unit 108 is configured to read data from and write data to memory 110. In various embodiments, memory 110 includes non-volatile memory, such as optical drives, magnetic drives, flash drives, or other storage. In some embodiments, separate data stores, such as an external data stores (not shown) included in a network (“cloud storage”) can supplement the memory 110. The user interface application 112 within memory 110 can be executed by the processing unit 108 to implement the overall functionality of the computing device 102.

User interface application 112 generates a user interface according to various embodiments. The user interface includes an interactive user interface for visualizing and managing a daily schedule of events and activities for those users whose cognitive deficits (e.g. dementia, dyslexia, ADHD) may preclude the use of traditional analog and digital clocks is disclosed. Common effects of cognitive decline relative to perception of time include dyschronometria (inability to gauge how much time has passed), impaired temporal context (difficulty of positioning one's self in the context of the day) and impaired temporal distance (difficulty in judging the proximity of past or future events relative to the present time). These impairments often lead to disorientation, confusion, anxiety and fearfulness, all of which negatively impact quality of life.

Analog and digital clocks typically present single points in time without positioning of any impending or past events. In addition, each relies on the use of numbers as part of the representation which can be confusing in yet another symptom of cognitive decline called dyscalculia. In some cases, the user's ability to read words on a display and manipulate a keyboard may not be present.

Embodiments of the disclosure provide a visualization of a day based on the amount of daylight and the amount of activity in the user's environment. It is assumed that more activity is occurring during the day than at night. Interaction is performed using a touch screen and information is presented both visually and through voice output. Each user can be unique in terms of their degree and type of cognitive impairment and so the system is highly configurable to provide the appropriate visualization.

The basic visualization of a day is a series of twenty-four bars of varying height and color. The colors represent daylight and the heights represent the activity level in the environment. The colors range from deep blue for nighttime hours to bright yellow for mid-day hours. User interface application 112 determines a plurality of increments associated with a day. The increments of a day can include, for example, a single hour in a day. User interface application 112 further determines a plurality of bars associated with the plurality of increments, where each of the plurality of bars is associated with a respective increment of the day. User interface application 112 then determines a respective height and a respective shading for each of the plurality of bars based on which increment of the day to which a respective bar corresponds. The respective height can be proportional to how far the bar is from a beginning or an end of the day, respectively. User interface application 112 also generates the user interface, where the user interface comprises the plurality of bars.

The bars in the user interface can be rendered as vertical bars. As referenced above, a respective height of each of the plurality of bars can be based on a temporal distance of the current time from noon on the current day. For example, for determining the respective height of each of the plurality of bars, user interface application 112 can associate a first height with a first bar corresponding to a first hour in the day after midnight (e.g. 12 AM-1 AM). The first height is the lowest or smallest height used in the user interface for the bars. The height of the next bar (e.g., 1 AM-2 AM) is taller than the first bar. The height of the next bar (e.g. 2 AM-3 AM) is higher still and each bar thereafter is greater in a graduated fashion until the twelfth hour from the beginning of the day (e.g. 11 AM-12 PM), which utilizes the highest height used for bars in the user interface. Next, the thirteenth bar from the beginning of the day (e.g., 12 PM-1 PM) is also rendered using the same height as the twelfth bar. From there, the height of the bars decreases in height in a graduated fashion downwards until the twenty-fourth bar corresponding to the twenty-fourth hour in the day after midnight (e.g. 11 PM-12 AM), which uses the first height, or the same as the height of the first bar in the user interface. The plurality of bars in the user interface are arranged adjacently according to a time of day, meaning that the bar for the first hour of the day is adjacent to the second hour of the day, and so on.

User interface application 112 also renders appointments and other events in the user interface. For example, user interface application 112 determines from a calendar or an appointments list accessible the computing device 102 an appointment associated with a user. User interface application 112 also determines an increment of the day, such as an hour in the day, with which the appointment is associated. User interface application 112 renders an appointment indicator in proximity to or adjacent to the increment of the day associated with the appointment.

User interface application 112 can also render one or more mealtime indicators in proximity to a respective one of the bars corresponding to an increment of the day. User interface application 112 can also render a current time indicator. For example, user interface application 112 determines a current time of day and renders, in the user interface, a current time of day indicator in proximity to a respective one of the bars corresponding to an increment of the day corresponding to the current time of day. The current time of day indicator can include an indicator line that bisects or intersects a respective one of the bars at a location corresponding to the current time of day.

In some embodiments, user interface application 112 allows users to define various user profiles or define various daily schedules that can be selected and displayed in a user interface. For example, user interface application 112 can store different daily schedules for a single user depending on the day of the week, month, or year. The different daily schedules can be selected and displayed by user interface application 112 depending on a current day of the week, month or year. Additionally, user interface application 112 can allow multiple users to define a daily schedule, which can be stored by user interface application 112 in computing device 102. In one embodiment, user interface application 112 displays a user profile selector so that a user can select a user profile to display a daily schedule associated with the user profile. In another embodiment, user interface application 112 can perform biometric identification or authentication of a user and select a corresponding user profile based on an identified user. The biometric signature of the user can be associated with the user profile, and the user interface application 112 can make a biometric authentication based on facial recognition, voice recognition, or fingerprint recognition of a user using a camera system, fingerprint reader, and/or a microphone system.

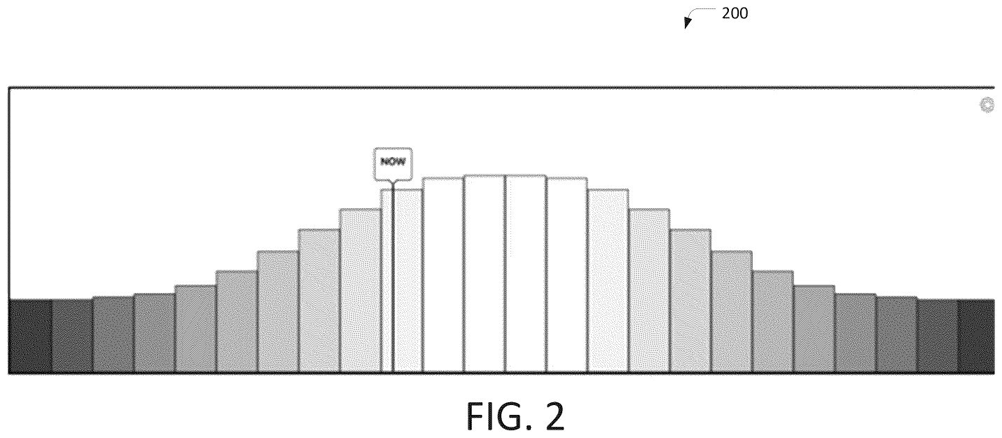

Referring to FIG. 2, an example user interface 200 generated by user interface application 112 is shown. An indicator (labeled “NOW”) shows the position of the current time within the day. This indicator is repositioned every minute, progressing left to right across the screen over the course of twenty-four hours.

Daily events and activities are positioned on the display, usually by a caregiver. These events may include appointments, classes, medication reminders, meals and exercise. When the user touches an event, the amount of time until or since that event is displayed and can be optionally announced in a natural human voice,

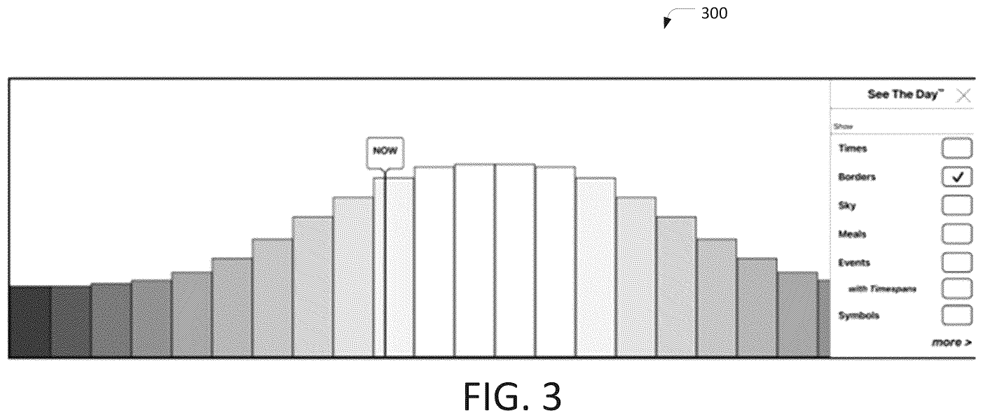

In one embodiment, user interface application 112 is implemented as a single-page web application (SPA) and is supported on multiple operating systems and devices. It is written in JavaScript and uses the ReactJS framework. The software uses a set of state variables (toggles) to determine variations of the display. As shown in the user interface 300 of FIG. 3, the state variables are set using on-screen touch menus and checkboxes. The menus appear when the “gear” icon in the upper right corner of the display is touched.

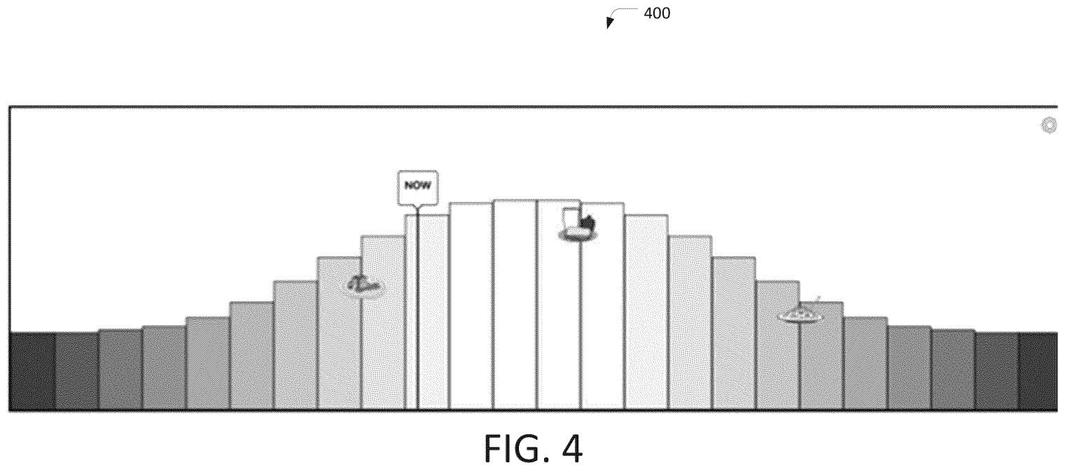

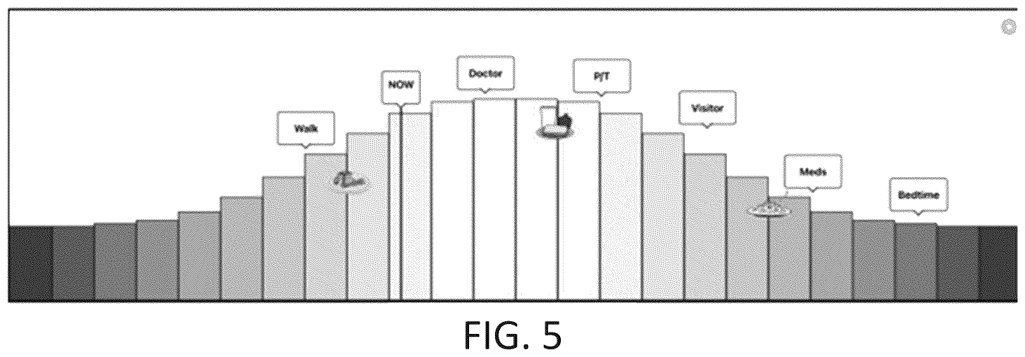

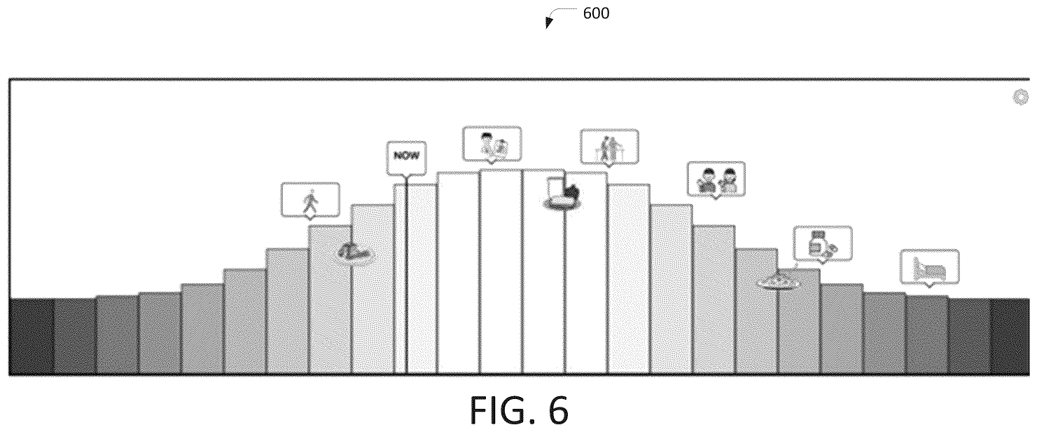

User interface application 112 can also generate a user interface 400 that includes mealtime indicators that are adjacent to the one or more bars that indicate in increment of a given day as shown in FIG. 4. The increment of a day can be an hour within a day. However, other increments can be utilized, such as a 30-minute increment, a multi-hour increment, or other portions of the day. As shown in user interface 500 in FIG. 5, the user interface application 112 can also render events, activities, or appointments in the user interface 400. In another embodiment, as shown in user interface 600 of FIG. 6, the user interface application 112 can also render events, activities, or appointments in the user interface 400 using symbols or icons in place of text.

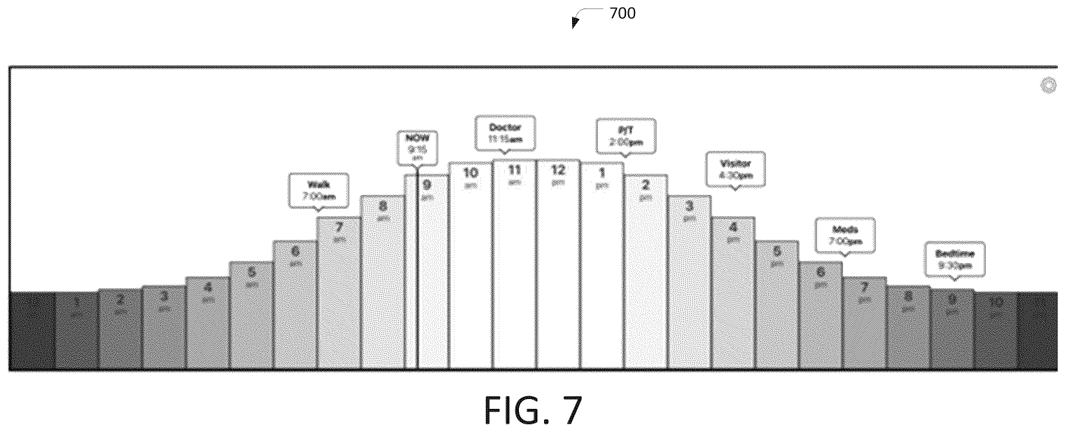

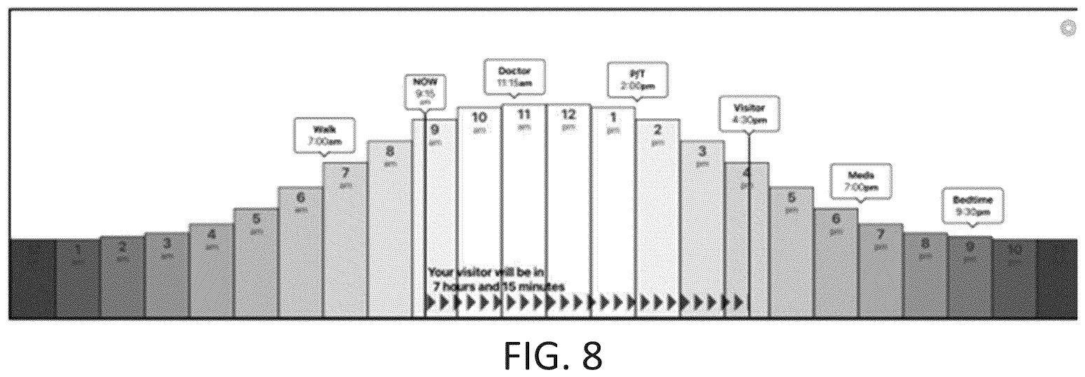

As illustrated in user interface 700 of FIG. 7, the time of day associated with a respective bar in the user interface is displayed as text on the respective bars and/or on indicators associated with events or appointments. As shown in user interface 800 of FIG. 8, timespans between an event that is touched or clicked and the present time is rendered by user interface application 112. In this scenario, user interface application 112 calculates an amount of time between the current time and an event that is touched by the user. The calculated amount of time is placed into the user interface 800. In some cases, user interface application 112 causes a voice announcement of the calculated amount of time by a speaker system associated with the device rendering the user interface 800. In one embodiment, voice announcements are generated using the SpeechSynthesis Web API on systems where it is supported or any feasible text-to-speech framework. On other systems, voice announcements are generated using open source text-to-speech software. Timespans can be expressed in exact time (e.g. “3 hours and 54 minutes”) or in approximate time (e.g. “almost 4 hours”).

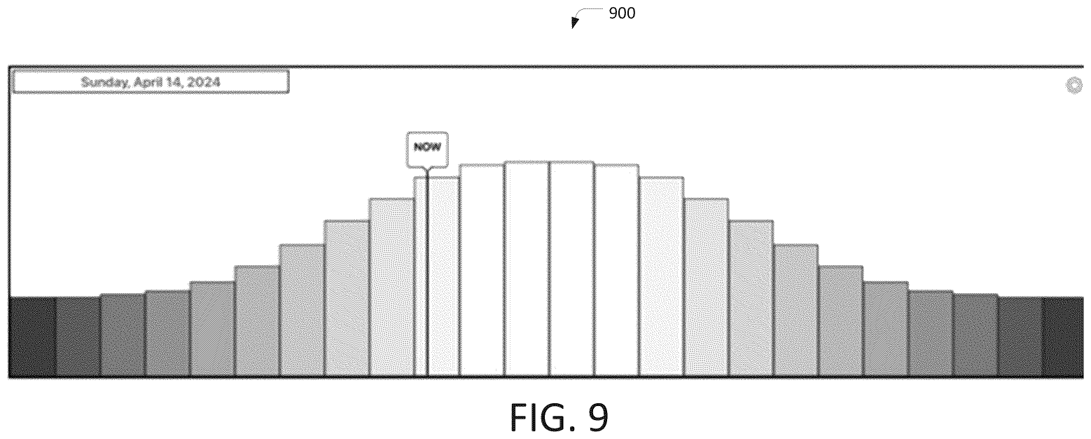

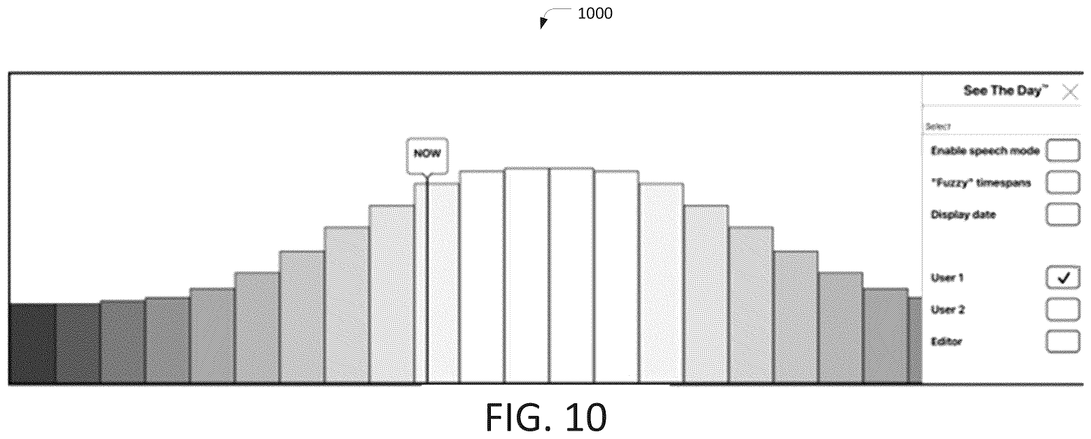

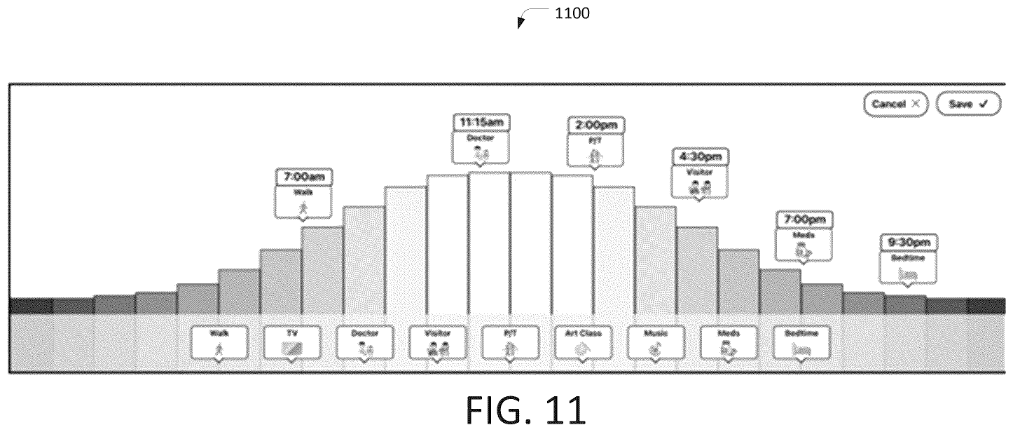

As shown in the user interface 900 of FIG. 9, user interface application 112 causes display of the current date and day of the week within the user interface 900. As shown in the user interface 1000 of FIG. 10, setting the events and activities on the daily schedule is performed by selecting the “Editor” toggle on the settings menu. When in edit mode, the user can add, remove and reposition events by dragging and dropping event indicators using the touch screen. In some implementations, as shown in the user interface 1100 of FIG. 11, available events are displayed along the bottom of the screen and they can be dragged up to the desired position on the schedule. Conversely, an event can be removed by dragging it down to the bottom or the screen.

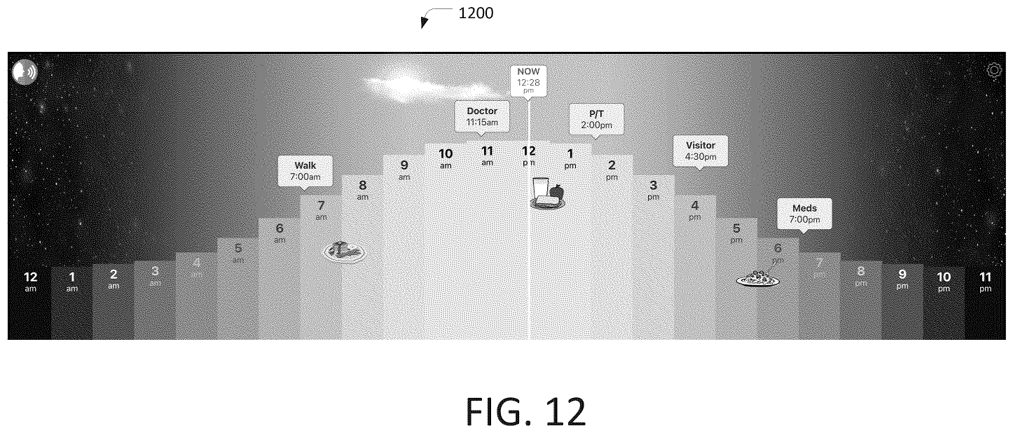

As shown in the user interface 1200 of FIG. 12, user interface application 112 generates a daytime and/or nighttime background depending upon the current time of day. In the depicted example, because the current time of day is 12:28 PM, a daylight background is shown.

In some cases, user interface application 112 supports a user interface that includes information, such as events and appointments, for multiple users and/or multiple schedules per user (e.g. for different days of the week). Additionally, user interface application 112 supports various modes of operation. When used in the home, a caregiver would use the edit mode to set the events for one or more days. The end user would view the display and recognize that different events occur in different parts of the day, some earlier and some later than others. Touching an event would display (and optionally announce) the amount of time since or until that event. Touching the “NOW” indicator would announce the current time and the timespan until the next event. These features directly address the cognitive deficits related to time perception.

When used in a care facility, the invention would be used to display scheduled events and activities (meals, classes, etc.) for the facility as a whole. In addition, individual users' schedules would also be available to users who identified themselves (e.g. by entering a passcode).

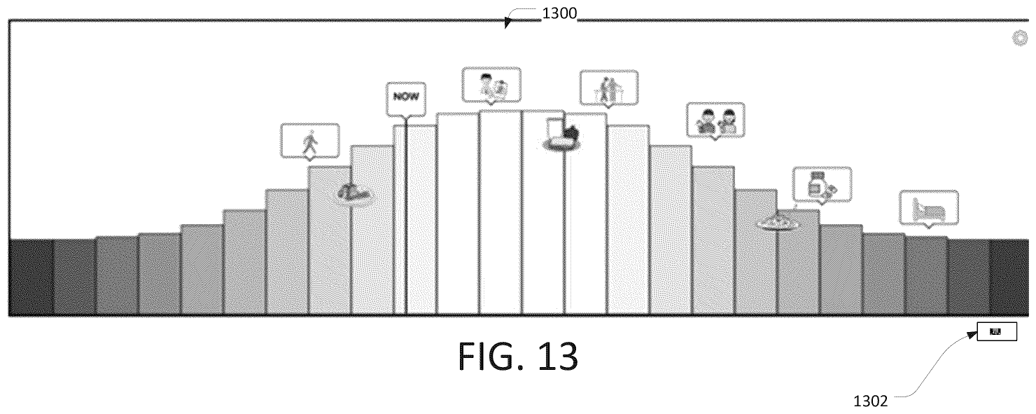

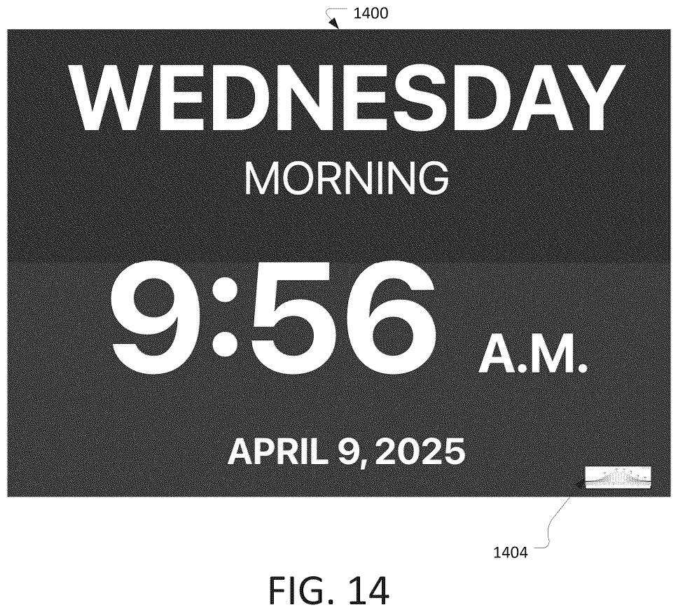

FIG. 13 illustrates an alternative user interface 1300 according to various embodiments. In the example of FIG. 13, the user interface 1300 includes a dementia clock toggle 1302, which allows the user to toggle between the illustrated time display and a more traditional dementia clock that is familiar to certain users. Continuing the example of FIG. 13, reference is made to FIG. 14, which illustrates user interface 1400. In the example of FIG. 14, the user has activated the dementia clock toggle 1302 of FIG. 13. In response to the user activating the toggle, user interface application 112 renders the user interface 1400 with the dementia clock. The user interface 1400 includes a toggle 1404 that allows the user to toggle away from the dementia clock and towards the clock user interface of FIG. 13 or any of the other examples illustrated herein. In this way, users of embodiments of the disclosure can toggle between different user interfaces depending upon their needs and cognitive abilities.

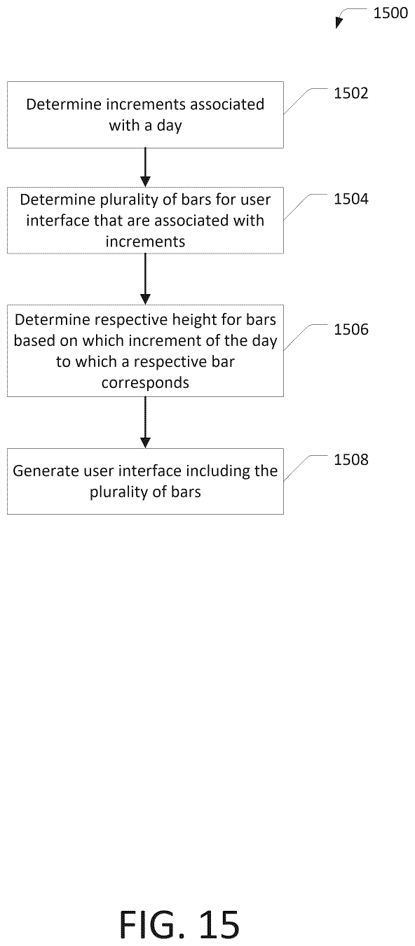

FIG. 15 is a flow diagram of method steps for generating a user interface, according to various embodiments. Although the method steps are described with reference to the embodiments of FIGS. 1-14, persons skilled in the art will understand that any system configured to implement the method steps, in any order, falls within the scope of the present disclosure.

As shown, the method 1500 begins at step 1502, where speaker protection application 112 determines a plurality of increments associated with a day that will be rendered in a user interface. The increments can correspond to equal portions of a day, such as each hour in the day. In some embodiments, a different increment can be chosen, such as a 15 minute increment, a 30 minute increment, a two hour increment, or any other portion of the day.

At step 1504, user interface application 112 determines or generates a plurality of bars that will be rendered in the user interface. Each bar represents one of respective increment of the day. For example, a single bar represents a single hour in the day. At step 1506, user interface application 112 determines a respective height for each of the plurality of bars based on which increment of the day to which a respective bar corresponds. The respective height can be proportional to how far the bar is from a beginning or an end of the day, respectively. In some embodiments, user interface application 112 determines a respective shading, which can be greyscale or color, of a respective bar based on how which increment of the day with which the bar is associated. For example, a bar associated with an hour at night is shaded or colored with darker colors, and a bar associated with an hour during the day is shaded with lighter colors. A bar associated with dawn or dusk is shaded with colors that are intermediate between a dark color used for night and a light color used for day.

In some embodiments, user interface application 112 also generates and inserts other indicators into the user interface. For example, as noted above, user interface application 112 can insert appointment indicators, mealtime indicators, and other event indicators. The indicators can include symbols, text, or a combination thereof. Additionally, user interface application 112 can provide configurability so that a user can configure the manner in which the indicators are displayed within the user interface.

At step 1508, user interface application 112 generates the user interface, where the user interface comprises the plurality of bars. In one embodiment, user interface application 112 is implemented as a single-page web application (SPA) and is supported on multiple operating systems and devices. The user interface is deployed using JavaScript and the ReactJS framework. The software uses a set of state variables (toggles) to determine variations of the display. In another example, user interface application 112 generates a browser page incorporating the user interface that is transmitted to another device that renders the user interface.

In sum, a user interface application generates a user interface. The user interface application determines a plurality of increments associated with a day as well as a plurality of bars associated with the plurality of increments, where each of the plurality of bars is associated with a respective increment of the day. Additionally, the user interface application determines a respective height and a respective shading for each of the plurality of bars based on which increment of the day to which a respective bar corresponds. The user interface application also generates the user interface, wherein the user interface comprises the plurality of bars.

At least one technical advantage of the disclosed techniques herein relative to the prior art is that, with the disclosed techniques, a user interface is presented to the user the conveys important information about the user's daily schedule, such as appointments, mealtimes, activities, and other information that can be important to convey to a user that may have cognitive deficits. Another advantage is that the user interface conveys time of day relative to events in a user's schedule to users with cognitive deficits. These technical advantages provide one or more technological improvements over prior art approaches.
1. In some embodiments, a computer-implemented method for presenting a user interface of a daily schedule, the computer-implemented method comprises determining a plurality of increments associated with a day, determining a plurality of bars associated with the plurality of increments, wherein each of the plurality of bars is associated with a respective increment of the day, determining a respective height and a respective shading for each of the plurality of bars based on which increment of the day to which a respective bar corresponds, and generating the user interface, wherein the user interface comprises the plurality of bars.
2. The computer-implemented method of clause 1, wherein each of the plurality of bars corresponds to a respective hour in the day.
3. The computer-implemented method of clauses 1 or 2, wherein the plurality of bars are rendered as vertical bars in the user interface.
4. The computer-implemented method of any of clauses 1-3, wherein determining the respective height of each of the plurality of bars further is based on a temporal distance from noon on the day.
5. The computer-implemented method of any of clauses 1-4, wherein determining the respective height of each of the plurality of bars further comprises associating a first height with a first bar corresponding to a first hour in the day after midnight, wherein the first height is a lowest height of the plurality of bars, associating a second height with a twelfth bar corresponding to a twelfth hour in the day after midnight, wherein the second height is an highest height of the plurality of bars, associating the second height with a thirteenth bar corresponding to a thirteenth hour in the day after midnight, and associating the first height with a twenty-fourth bar corresponding to a twenty-fourth hour in the day after midnight.
6. The computer-implemented method of any of clauses 1-5, wherein a respective height of a subset of the plurality of bars between the first bar and the twelfth bar increase in height in a graduated fashion.
7. The computer-implemented method of any of clauses 1-6, wherein a respective height of a subset of the plurality of bars between the thirteenth bar and the twenty-fourth bar decrease in height in a graduated fashion.
8. The computer-implemented method of any of clauses 1-7, wherein the plurality of bars are arranged adjacently according to a time of day.
9. The computer-implemented method of any of clauses 1-8, further comprising determining an appointment associated with a user, determining an increment of the day with which the appointment is associated, and associating the appointment with the increment of the day.
10. The computer-implemented method of any of clauses 1-9, further comprising rendering, in the user interface, a graphical indication of the appointment in proximity to a respective one of the bars corresponding to the increment of the day.
11. The computer-implemented method of any of clauses 1-10, further comprising rendering, in the user interface, a mealtime indicator in proximity to a respective one of the bars corresponding to an increment of the day.
12. The computer-implemented method of any of clauses 1-11, further comprising determining a current time of day, and rendering, in the user interface, a current time of day indicator in proximity to a respective one of the bars corresponding to an increment of the day corresponding to the current time of day.
13. The computer-implemented method of any of clauses 1-12, wherein the current time of day indicator comprises an indicator line that bisects the respective one of the bars at a location corresponding to the current time of day.
14. In some embodiments, one or more non-transitory computer-readable media store instructions that, that, when executed by one or more processors, cause the one or more processors to perform the steps of determining a plurality of increments associated with a day, determining a plurality of bars associated with the plurality of increments, wherein each of the plurality of bars is associated with a respective increment of the day, determining a respective height and a respective shading for each of the plurality of bars based on which increment of the day to which a respective bar corresponds, and generating a user interface, wherein the user interface comprises the plurality of bars.
15. The one or more non-transitory computer-readable media of clause 14,wherein each of the plurality of bars corresponds to a respective hour in the day.
16. The one or more non-transitory computer-readable media of clauses 14 or 15, wherein the plurality of bars are rendered as vertical bars in the user interface.
17. The one or more non-transitory computer-readable media of any of clauses 14-16, wherein determining the respective height of each of the plurality of bars further is based on a temporal distance from noon on the day.
18. The one or more non-transitory computer-readable media of any of clauses 14-17, further comprising determining an appointment associated with a user, determining an increment of the day with which the appointment is associated, and associating the appointment with the increment of the day.
19. The one or more non-transitory computer-readable media of any of clauses 14-18, further comprising rendering, in the user interface, a graphical indication of the appointment in proximity to a respective one of the bars corresponding to the increment of the day.
20. In some embodiments, a system comprises a memory storing instructions for a user interface application, and a processor coupled to the memory that implements the user interface application by performing the steps of determining a plurality of increments associated with a day, determining a plurality of bars associated with the plurality of increments, wherein each of the plurality of bars is associated with a respective increment the day, determining a respective height and a respective shading for each of the plurality of bars based on which increment of the day to which a respective bar corresponds, and generating the user interface, wherein the user interface comprises the plurality of bars.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for presenting a user interface of a daily schedule, the computer-implemented method comprising:
determining a plurality of increments associated with a day;
determining a plurality of bars associated with the plurality of increments, wherein each of the plurality of bars is associated with a respective increment of the day;
determining a respective height and a respective shading for each of the plurality of bars based on which increment of the day to which a respective bar corresponds; and
generating the user interface, wherein the user interface comprises the plurality of bars.

2. The computer-implemented method of claim 1, wherein each of the plurality of bars corresponds to a respective hour in the day.

3. The computer-implemented method of claim 1, wherein the plurality of bars are rendered as vertical bars in the user interface.

4. The computer-implemented method of claim 3, wherein determining the respective height of each of the plurality of bars further is based on a temporal distance from noon on the day.

5. The computer-implemented method of claim 3, wherein determining the respective height of each of the plurality of bars further comprises:
associating a first height with a first bar corresponding to a first hour in the day after midnight, wherein the first height is a lowest height of the plurality of bars;
associating a second height with a twelfth bar corresponding to a twelfth hour in the day after midnight, wherein the second height is an highest height of the plurality of bars;
associating the second height with a thirteenth bar corresponding to a thirteenth hour in the day after midnight; and
associating the first height with a twenty-fourth bar corresponding to a twenty-fourth hour in the day after midnight.

6. The computer-implemented method of claim 5, wherein a respective height of a subset of the plurality of bars between the first bar and the twelfth bar increase in height in a graduated fashion.

7. The computer-implemented method of claim 5, wherein a respective height of a subset of the plurality of bars between the thirteenth bar and the twenty-fourth bar decrease in height in a graduated fashion.

8. The computer-implemented method of claim 3, wherein the plurality of bars are arranged adjacently according to a time of day.

9. The computer-implemented method of claim 1, further comprising:
determining an appointment associated with a user;
determining an increment of the day with which the appointment is associated; and
associating the appointment with the increment of the day.

10. The computer-implemented method of claim 9, further comprising:
rendering, in the user interface, a graphical indication of the appointment in proximity to a respective one of the bars corresponding to the increment of the day.

11. The computer-implemented method of claim 1, further comprising:
rendering, in the user interface, a mealtime indicator in proximity to a respective one of the bars corresponding to an increment of the day.

12. The computer-implemented method of claim 1, further comprising:
determining a current time of day; and
rendering, in the user interface, a current time of day indicator in proximity to a respective one of the bars corresponding to an increment of the day corresponding to the current time of day.

13. The computer-implemented method of claim 12, wherein the current time of day indicator comprises an indicator line that bisects the respective one of the bars at a location corresponding to the current time of day.

14. One or more non-transitory computer-readable media storing instructions that, that, when executed by one or more processors, cause the one or more processors to perform the steps of:
determining a plurality of increments associated with a day;
determining a plurality of bars associated with the plurality of increments, wherein each of the plurality of bars is associated with a respective increment of the day;
determining a respective height and a respective shading for each of the plurality of bars based on which increment of the day to which a respective bar corresponds; and
generating a user interface, wherein the user interface comprises the plurality of bars.

15. The one or more non-transitory computer-readable media of claim 14, wherein each of the plurality of bars corresponds to a respective hour in the day.

16. The one or more non-transitory computer-readable media of claim 14, wherein the plurality of bars are rendered as vertical bars in the user interface.

17. The one or more non-transitory computer-readable media of claim 16, wherein determining the respective height of each of the plurality of bars further is based on a temporal distance from noon on the day.

18. The one or more non-transitory computer-readable media of claim 14, further comprising:
determining an appointment associated with a user;
determining an increment of the day with which the appointment is associated; and
associating the appointment with the increment of the day.

19. The one or more non-transitory computer-readable media of claim 18, further comprising:
rendering, in the user interface, a graphical indication of the appointment in proximity to a respective one of the bars corresponding to the increment of the day.

20. A system comprising:
a memory storing instructions for a user interface application; and
a processor coupled to the memory that implements the user interface application by performing the steps of:
determining a plurality of increments associated with a day;
determining a plurality of bars associated with the plurality of increments, wherein each of the plurality of bars is associated with a respective increment of the day;
determining a respective height and a respective shading for each of the plurality of bars based on which increment of the day to which a respective bar corresponds; and
generating the user interface, wherein the user interface comprises the plurality of bars.
